(19) United States
(12) Patent Application Publication
(10) Pub. No.: US 2022/0363415 A1
(43) Pub. Date: Nov. 17, 2022

(54) DEEP REINFORCEMENT LEARNING METHOD FOR CONTROLLING ORBITAL TRAJECTORIES OF SPACECRAFTS IN MULTI-SPACECRAFT SWARM

(71) Applicant: Orbital AI LLC, Detroit, MI (US)

(72) Inventor: Tracie Renea Conn, Grosse Pointe Woods, MI (US)

(73) Assignee: Orbital AI LLC, Detroit, MI (US)

(21) Appl. No.: 17/318,390

(22) Filed: May 12, 2021

(51) Int. Cl. B64G 1/24; G05B 13/02

(52) U.S. Cl. CPC B64G 1/242; G05B 13/027; B64G 2001/247; B64G 2001/245

(57) ABSTRACT

The present disclosure provides a method for controlling orbital trajectories of a plurality of spacecraft in a multi-spacecraft swarm. In one aspect, the method includes deploying a DRL agent including a plurality of trajectory control models to the multi-spacecraft swarm, the trajectory control models corresponding to swarm configurations of the multi-spacecraft swarm; determining a state vector of said plurality of spacecraft in the multi-spacecraft swarm; transmitting a collective command to the multi-spacecraft swarm, such that said plurality of spacecraft in the multi-spacecraft swarm are to be distributed in one of the swarm configurations; determining actions of said plurality of spacecraft based on the state vector and the collective command; and maneuvering the multi-spacecraft swarm in accordance with the actions.

### STATEMENT REGARDING GOVERNMENT SPONSORED RESEARCH OR DEVELOPMENT

This invention was made with U.S. Government support under contract number 2022349 awarded by the National Science Foundation (NSF) through its SBIR program. The U.S. Government has certain rights in this invention.

### TECHNICAL FIELD

The present disclosure relates to a method for controlling orbital trajectories of spacecrafts in a multi-spacecraft swarm.

### BACKGROUND

Swarms are several (more than 3) small spacecraft, such as CubeSats, in orbit close together in a desired distribution or formation. Swarms are distinct from constellations in that constellations of spacecraft are separated to achieve global coverage while swarms are deployed to orbit in close proximity to one another and/or close to other objects. FIG. 1A illustrates a constellation 10 of a multi-spacecraft system including a plurality of spacecraft 12. FIG. 1B illustrates a swarm 20 of a multi-spacecraft system including a plurality of spacecraft 22 arranged relative to each other in a desired formation. See, e.g., Refs. [1] and [2].

While scheduling and station-keeping for constellations has become semi-autonomous, automated trajectory planning for spacecraft swarms is a documented technology gap. For example, NASA's Small Spacecraft Technology Plan identifies a technology gap for sensor-driven guidance and control technologies, and prioritizes investment in technology that would operate a spacecraft swarm as a single unit. See, e.g., Ref. [3]. NASA's Strategic Plan includes the need to partner on capabilities that enable tightly controlled formations of spacecraft for Very-Long-Baseline Interferometry, synthetic aperture synthesis, and other precision collective measurement. See, e.g., Ref. [4].

Spacecraft swarms are a relatively new mission concept, reflecting a paradigm shift in space mission design. Whereas in the past, mission designers might send a single large Flagship-class spacecraft, new proposed mission concepts include sending a few smaller accompanying probes along with the main large spacecraft, or sending hundreds of toaster-sized satellites in lieu of a larger one. Such mission concepts are referred to as “sensor webs,” “networked systems,” and “distributed missions.”

Multi-spacecraft systems offer new advantages and capabilities compared to single-spacecraft missions of the past:

1. A swarm allows for multi-point, simultaneous measurements across a 3D volume of space, as opposed to sampling from one single spacecraft orbiting alone.

2. The distribution of the spacecraft can be designed according to the phenomena being studied, enabling optimal scientific data collection.

3. The system can be responsive, repositioning itself according to real-time conditions. For example, a swarm may change its formation in response to growing error in a machine learning model.

4. Fractionalized architectures allow for individual spacecraft in the swarm to be replaced as needed for continuous upgrades, enabling agile and adaptable missions to handle the unexpected.

5. A swarm of small spacecraft could coordinate to assemble large components in space, such as, telescopes or arrays that are too large to launch in one piece.

Recent advances in propulsion, networking, miniaturization of spacecraft components, and enhanced sensing provide many of the necessary features required for spacecraft swarm missions. Trajectory planning and control of the swarm as one unit/system is still an outstanding need.

The present disclosure relates to the state-of-the-art of two engineering areas: guidance and control of multi-spacecraft systems, and deep reinforcement learning.

Guidance and control for formation flying, rendezvous, and proximity operations have been an active research topic for many years. Guidance refers to determining the desired orbital path of travel of a spacecraft, and control refers to calculating and executing the propulsion maneuvers required to move the spacecraft from the current orbital path to the desired orbital path. Published methods exist for multi-spacecraft missions such as Magnetospheric Multiscale Mission (MMS) (see, Ref. [5]), Cluster II (see, Ref. [6]), and the AVANTI rendezvous experiment (see, Ref. [7]), but these methods have several limitations when we consider scaling them to deep-space sensor webs of dozens of CubeSats. First, the current approaches require Earthbound experts-in-the-loop for monitoring, trajectory planning, commanding, and issuing Go/NoGo decisions. Such an approach scales the operations cost with the number of spacecraft in the swarm, since more spacecraft would require more human flight controllers to command and control spacecraft-by-spacecraft. Depending on human oversight is not an ideal strategy for deep space due to time delays and dependency on uplink/downlink data transfers.

Furthermore, and more specifically concerning the method of trajectory design and control, optimal control strategies such as MMS′ formation maneuver design process do not scale to large swarms. MMS, as is still the case with published formation flying algorithms, performs positioning of the individual spacecraft relative to a target satellite via optimization techniques. MMS operators, through iterative evaluation of possible maneuvers, remaining fuel, and other considerations, determine a reference satellite and the sequence of maneuvers for three remaining spacecraft in the tetrahedron. Each MMS maneuver is commanded and monitored one by one to position each spacecraft into an identified position relative to a reference spacecraft to form the tetrahedron formation.

Classical control and model predictive control (MPC) techniques are only applicable to such use cases where the goal state can be demonstrated to the algorithm That is, there must be a defined reference signal (i.e., error) that is a function of the observable states. The control algorithm then seeks to minimize the error. For rendezvous or formation flying, the goal state is clear: solve for maneuvers for “spacecraft A” to move into “orbital position slot x.” The cost function to be reduced is an expression for the inter-satellite range or relative orbital elements, and is straightforward to solve via optimization techniques.

An MPC approach does not align with the science goals for spacecraft swarm missions, where the objective is for the swarm to work in concert and achieve an overall distribution. Consider a notional sensor web of 100 spacecraft: the objective is for the swarm to coordinate in a safe and fuel-efficient manner to achieve a desired distribution for multi-point measurements. We cannot define the goal orbital states of the 100 individual spacecraft because there may be too many (infinitely many) parameters to achieve the desired distribution requirement for science observations. For example, consider a notional command to the swarm such as “achieve ten 1000 km inter-satellite baselines and twenty 500 km baselines for heliophysics measurements.” For such a requirement, framing the trajectory control problem such that each spacecraft has a specific, unique goal orbital position state is a rigid approach and is unnecessarily constraining.

Also, an MPC approach deployed on-orbit to solve swarm trajectory control is computationally heavy because it requires the forward propagation of all spacecraft states over the MPC time horizon while attempting to minimize a cost function. Iteratively evaluating the time horizon for 100 spacecraft states may be feasible for an automated operations tool on Earth with generous computational resources (GPUs, memory, power), but this optimal control approach does not seem transferable to the constrained computer platforms that must perform autonomous swarm guidance and control in deep space. With a focus on eventual automated swarm trajectory control in deep space, the present disclosure provides a more efficient and robust control approach.

### REFERENCES

[1] National Coordination Office for Space-Based Positioning, Navigation, and Timing, “GPS Constellation Arrangement,” accessed Feb. 13, 2021. gps.gov/multimedia/images/constellation.jpg
[2] Conn, Tracie, Andres Perez, Laura Plice, and Michael Ho, “Operating Small Sat Swarms as a Single Entity: Introducing SODA,” 2017 Small Satellite Conference. digitalcommons.usu.edu/smallsat/2017/all2017/100/
[3] NASA Small Spacecraft Technology Program, “Small Spacecraft Technology Plan,” 2020, pp 21, 24. beta.sam.gov/opp/8bc8adb9fb234582a5a64b250a1def31/view
[4] NASA Small Spacecraft Coordination Group, “NASA Small Spacecraft Strategic Plan,” 2019, pp 6-7. nasa.gov/sites/default/files/atoms/files/smallsatstrategicplan-190805.pdf
[5] Williams, Trevor W., et al. “Initial Satellite Formation Flight Results from the Magnetospheric Multiscale Mission.” AIAA/AAS Astrodynamics Specialist Conference (2016).
[6] The European Space Agency, “Cluster's 20 years of studying Earth's magnetosphere,” (2020). esa.int/Science_Exploration/Space_Science/Cluster/Cluster_s_20_years_of_studying_Earth_s_magentosphere
[7] Gaias, Gabriella, and Jean-Sébastien Ardaens. “In-orbit experience and lessons learned from the AVANTI experiment.” Acta Astronautica 153 (2018): 383-393.
[8] Sutton, Richard S., and Andrew G. Barto. Reinforcement learning: An introduction. MIT press (2018): p 48.
[9] Izzo, Dario, Marcus Märtens, and Binfeng Pan. “A Survey on Artificial Intelligence Trends in Spacecraft Guidance Dynamics and Control.” arXiv preprint arXiv:1812.02948 (2018): pp 12-13.
[10] Hovell, Kirk, and Steve Ulrich. “On Deep Reinforcement Learning for Spacecraft Guidance.” AIAA Scitech 2020 Forum. 2020.
[11] Miller, Daniel, and Richard Linares. “Low-thrust optimal control via reinforcement learning.” 29th AAS/AIAA Space Flight Mechanics Meeting. 2019.
[12] Chu, X., et al. “Q-learning algorithm for path-planning to maneuver through a satellite cluster.” 2018 AAS/AIAA Astrodynamics Specialist Conference. 2018.
[13] Gaudet, Brian, Richard Linares, and Roberto Furfaro. “Deep reinforcement learning for six degree-of-freedom planetary landing.” Advances in Space Research 65.7 (2020): 1723-1741.

### SUMMARY

Embodiments of the present disclosure provide a method for controlling orbital trajectories of a plurality of spacecraft in a multi-spacecraft swarm. In one aspect, the method comprises: deploying a DRL agent including a plurality of trajectory control models to the multi-spacecraft swarm, the trajectory control models corresponding to swarm configurations of the multi-spacecraft swarm; determining a state vector of said plurality of spacecraft in the multi-spacecraft swarm; transmitting a collective command to the multi-spacecraft swarm, such that said plurality of spacecraft in the multi-spacecraft swarm are to be distributed in one of the swarm configurations; determining actions of said plurality of spacecraft based on the state vector and the collective command in accordance with one of the trajectory control models of the DRL agent; and maneuvering the multi-spacecraft swarm in accordance with the actions.

In one embodiment, prior to deploying the DRL agent, the method further comprises training the DRL agent using a high-fidelity orbital mechanics simulation.

In one embodiment, training the DRL agent policy comprises: providing a positive reward signal to the DRL agent when said plurality of spacecraft maintains a desired separation distance between each other in a desired swarm configuration.

In one embodiment, training the DRL agent policy comprises: providing a negative reward signal to the DRL agent when longer than a preset time period is taken for said plurality of spacecraft to form the desired swarm configuration.

In one embodiment, training the DRL agent policy comprises: providing a negative reward signal to the DRL agent when more fuel than a preset amount is consumed for said plurality of spacecraft to maneuver the multi-spacecraft swarm in accordance with the actions.

In another aspect, the present disclosure provides a method for training a DRL agent of a spacecraft swarm including a plurality of spacecraft, the method comprising: (A) defining a first MDP state including first position and velocity states of the spacecraft propagated in a high-fidelity simulation environment for a plurality of time steps; (B) selecting from the DRL agent first actions for the spacecraft to maneuver, the first actions including a velocity change of each of the spacecraft and an exploration noise; (C) maneuvering the spacecraft in a high-fidelity simulation environment in accordance with the first actions for said plurality of time steps, thereby generating a second MDP state including second position and velocity states of the spacecraft for said plurality of time steps; (D) calculating a reward signal based on the first actions and the second MDP state; (E) replacing the first MDP state by the second MDP state, if the reward signal is positive; and (F) storing the first MDP state as a part of the DRL agent.

In one embodiment, the method further comprises repeating steps (B) through (E) until a preset condition is met.

In one embodiment, the preset condition includes at least one of an elapsed time being greater than a mission time, an expended fuel amount being greater than a budgeted fuel amount, a minimum spacecraft altitude being less than a minimum allowed altitude, and a closest distance among two of the spacecraft being less than a collision keep-out zone distance.

In one embodiment, the method further comprises evaluating the DRL agent in a simulation environment with randomized testing conditions.

In one embodiment, evaluating the DRL agent comprises: providing different initial conditions of the spacecraft in the simulation environment; maneuvering the spacecraft in the simulation environment using various actions in the DRL agent; and determining evaluation metrics for the spacecraft to maneuver in accordance with said various actions.

In one embodiment, the method further comprises introducing perturbations to the simulation environment.

In one embodiment, the evaluation metrics comprise at least one of a cumulative reward, a complexity of computing the actions, a percentage that swarm formation requirements are satisfied, and a mission success rate defined as a ratio of a number of successfully completed simulated missions to a number of all simulated missions.

In one embodiment, calculating the reward signal comprises providing a positive value to the DRL agent when said plurality of spacecraft maintains a desired separation distance between each other in a desired swarm configuration.

In one embodiment, calculating the reward signal comprises providing a negative value to the DRL agent when longer than a preset time period is taken for said plurality of spacecraft to form a desired swarm configuration.

In one embodiment, calculating the reward signal comprises providing a negative value to the DRL agent when more fuel than a preset amount is consumed for said plurality of spacecraft to maneuver the spacecraft swarm in accordance with the actions.

### BRIEF DESCRIPTION OF THE DRAWINGS

FIG. 1A illustrates a constellation of a multi-spacecraft system.

FIG. 1B illustrates a swarm of a multi-spacecraft system.

FIG. 2 illustrates an interaction loop between agent and environment.

FIG. 3 illustrates a method for training a DRL agent, in accordance with an embodiment of the present disclosure.

FIG. 4 shows two examples of MDP state vectors, in accordance with an embodiment of the present disclosure.

FIG. 5 illustrates various example swarm configurations, each having a unique reward signal and resulting model.

FIG. 6 illustrates a fishbowl swarm formation with a radius pf.

FIG. 7 illustrates a flow chart for the interface between the orbital mechanics simulator inputs/outputs and the Markov Decision Process (MDP) state.

FIG. 8 illustrates a diagram of state inputs to various swarm configuration trajectory control models, in accordance with an embodiment of the present disclosure.

FIG. 9 shows an example pseudocode of the training process, in accordance with an embodiment of the present disclosure.

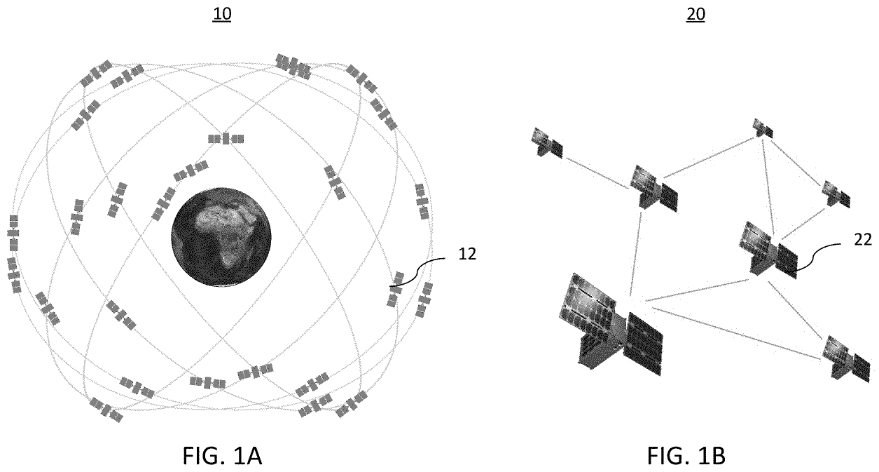

### DETAILED DESCRIPTION

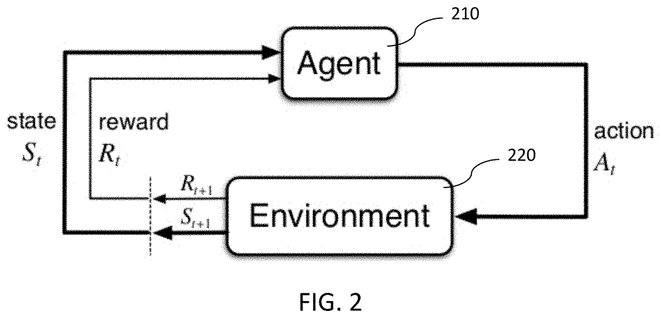

FIG. 2 illustrates an interaction loop between agent and environment in accordance with an embodiment of the present disclosure. The present disclosure provides a framework for training and evaluating a Deep Reinforcement Learning (DRL) agent 210 to design and control the trajectories of all individual spacecraft in a swarm, and then to deploy that agent for use in mission design and/or on-orbit real-time operations. The present disclosure focuses on, but not limited to, spacecraft with impulsive and finite maneuver capability, because such capabilities are readily available for spacecraft used in swarm systems (e.g., CubeSats).

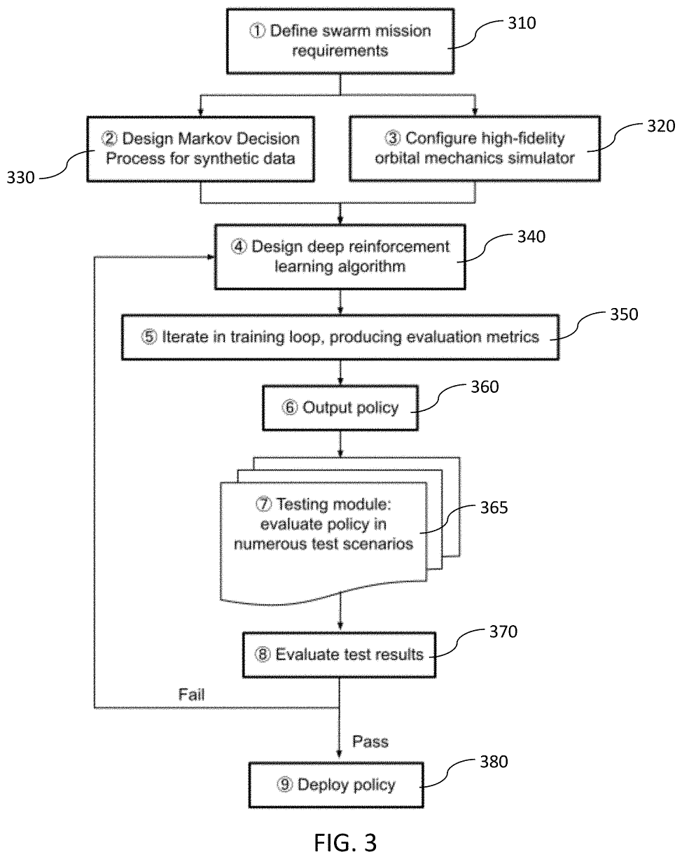

In one embodiment, the DRL agent 210 includes a deep artificial neural network that maps the current multi-spacecraft swarm system's state to the set of actions (maneuvers) At that each spacecraft should take to get into desired orbital trajectories. In the DRL literature, this is referred to as a deterministic policy, where the neural network maps the state to a deterministic set of actions. Algorithms such as deep deterministic policy gradient (DDPG), Twin Delayed DDPG algorithm (otherwise known as TD3), and the Forward-Looking Actor for Model-Free Reinforcement Learning (FORK) can be used to train such an agent. The DRL agent 210 can be trained with real world or simulated data. The present disclosure focuses on using high-fidelity orbital mechanics simulation to provide synthetic data for training. FIG. 3 illustrates a method for training a DRL agent, in accordance with an embodiment of the present disclosure.

In Step 310, the swarm mission requirements and objectives are defined, including but not limited to: which swarm formation type is required, the quantity of spacecraft in the swarm, attributes of each spacecraft (size, mass, coefficient of drag, maneuver capabilities, etc.), estimates of initial position and velocity states of each spacecraft following on-orbit deployment, etc.

In Step 320, a high-fidelity orbital mechanics simulator is configured. There are multiple simulation packages that can be used for this purpose and one option is GMAT (NASA's General Mission Analysis Tool), an open source, flight certified, high fidelity orbital simulation environment. The simulator is a library capable of modeling forces acting on the spacecraft, including gravity (from Earth, Moon, sun, and other planets), non-uniform gravity fields due to planet oblateness, atmospheric drag, solar radiation pressure, etc. The simulator also models spacecraft maneuvers, including impulsive, finite, and constant-thrust.

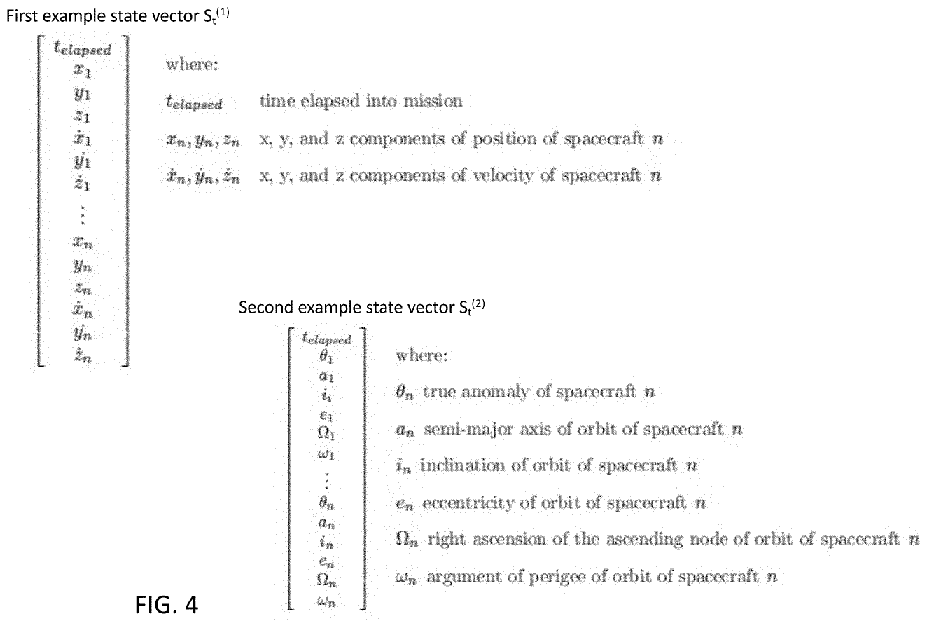

In Step 330, a Markov Decision Process (MDP) (states, actions, and reward signals) for the synthetic data is designed. The state vector St may include, but is not limited to: spacecraft positions, spacecraft velocities, relative position of one spacecraft with respect to another, fuel remaining for propulsion system, geographic location of target to be observed or measured, elapsed time into mission, time remaining in mission, etc. Two examples of MDP state vectors are shown in FIG. 4. The state vectors are populated with values from the simulation results during training

The actions At that the agent 210 learns to provide are impulsive or finite maneuvers for each spacecraft; these are referred to as Δv (delta-v, change in velocity). These actions Aₜ are a set of three delta-v values in a cartesian coordinate frame attached to the spacecraft body and moving with it. These actions Aₜ can also be, but not limited to, the amount of thrust each thruster in the spacecraft propulsion system needs to generate. These actions Aₜ, when executed by the spacecraft, would put them on the desired orbital trajectories. A maneuver may not be required for all spacecraft at the same time, so the output action can contain a Boolean to designate whether a maneuver is required, and if so, at what time in the future to execute it. For systems of constant thrust (e.g., an electric propulsion system), actions will contain the thrust vector for each spacecraft.

During training, a reward signal Rₜ must be provided to the agent 210. This is done based on the desired swarm configuration/formation. For example, a multi-spacecraft swarm system may be required to be configured such that pairs of spacecraft achieve a desired distance of separation, allowing for in-situ measurements between spacecraft. The reward function would then include a positive reward on how well the desired separation distance is maintained.

Another example can be that spacecraft swarm system is to be commanded to fly over a target of interest (i.e., a plume from the surface of Enceladus) in a stacked formation, simultaneously taking measurements at various altitudes above the target. In this case, the reward signal Rₜ would contain components with positive reward for the agent 210 on how well the spacecraft are in a stacked formation, penalties for the agent 210 on how long it takes to get the swarm system into formation, and positive rewards for the agent 210 for how well the coverage of the target of interest is.

Other swarm configuration command examples can be:

1. Maneuver the spacecraft system such that each one passes through an area in a train formation.

2. Maneuver the spacecraft as if they were constrained by some spherical boundary while avoiding spacecraft-to-spacecraft collision.

3. Maneuver the spacecraft to be equally dispersed throughout a specified 3D volume of space.

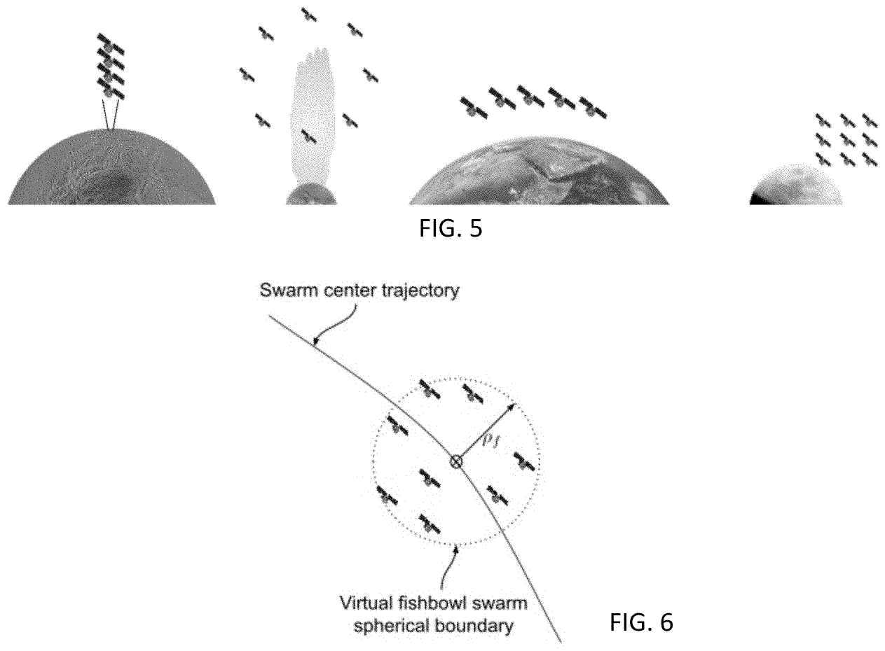

FIG. 5 illustrates various example swarm configurations, each having a unique reward signal and resulting model. The reward signal Rt plays a pivotal role in training the agent 210 and in the framework disclosed herein, allows for, but is not limited to, training an agent to design and control swarm spacecraft trajectories of the types listed above. The reward function is designed for a specified swarm configuration.

FIG. 6 illustrates a fishbowl swarm formation with a ratius ρ_{f}. The reward calculation for a fishbowl swarm type is provided as follows. In the fishbowl swarm configuration, each spacecraft in the n-spacecraft swarm must stay within a specified radius from the swarm center as illustrated in FIG. 6. The swarm center may be an actual spacecraft (e.g. the larger spacecraft from which the smaller swarm spacecraft were deployed), or the center may be represented by a virtual moving point on a defined orbital trajectory.

In Step 340, a deep reinforcement learning (DRL) algorithm is designed. One implementation of the MDP action is that the DRL agent 210 chooses a maneuver for each of n spacecraft in the swarm. For example, action At can be given by:

$${A}_{t} = [ \begin{matrix}Δ {v}_{{x}_{i} = 1} \\ Δ {v}_{{y}_{i} = 1} \\ Δ {v}_{{z}_{i} = 1} \\ ⋮ \\ Δ {v}_{{x}_{i} = n} \\ Δ {v}_{{y}_{i} = n} \\ Δ {v}_{{z}_{i} = n}\end{matrix} ]$$

where i is the index of individual spacecraft in the swarm, i=1→n. For a given MDP state Sₜ₊₁ and action Aₜ, the reward is calculated as:

$${r}_{i} = {\sum }_{τ = 1}^{N} {P}_{koz} - {\sum }_{i = 1}^{n} F ‖ Δ {\ddot{v}}_{i} ‖ + {\sum }_{τ = 1}^{N} {\sum }_{i = 1}^{n} ( {R}_{i , τ} + {P}_{i , τ} ) \qquad ( 1 )$$

where each term is defined as follows.

To train the agent 210 not to apply actions that result in spacecraft collisions, a keep-out zone is defined around each spacecraft, with a configurable radius ρ_{koz}. Let Pbe the set of all unique spacecraft pairs (a, b) in the n-spacecraft swarm, and ρ_{a,b} be the distance between them at a time step τ. A collision penalty is applied if any spacecraft encroaches into the keep-out zone (koz) around any other spacecraft. That is,

$${P}_{koz} = \{ \begin{matrix}- {p}_{koz} & if {ρ}_{a , b} \leq {ρ}_{koz} ∀ ( a , b ) ∈ 𝒫 \\ 0 & otherwise\end{matrix}$$

where p_{koz} is the scalar penalty applied if any spacecraft enters a keep-out zone.

To train the agent 210 to achieve the desired swarm formation using minimal fuel, a scalar F (fuel penalty) that penalizes fuel use is multiplied to the magnitude of each spacecraft's Δv maneuver, ∥Δv̅ᵢ∥, where Δv̅ᵢ is the action (change in velocity) of spacecraft i at time t.

Ri,τ is a formation reward/penalty term, determined for each spacecraft by whether or not the spacecraft was contained within the fishbowl swarm boundary radius at each time step τ=1→N. It is a scalar value r_{contained} if the satellite is within the virtual boundary, or a scalar value penalty r_{escaped} if the action taken by the DRL agent has resulted in the spacecraft moving too far away from the fishbowl swarm formation center.

$${R}_{i , τ} = \{ \begin{matrix}{r}_{contained} & if {ρ}_{i , c} \leq {ρ}_{f} \\ - {r}_{escaped} & if {ρ}_{i , c} > {ρ}_{f}\end{matrix} \qquad ( 2 )$$

The distance of each spacecraft from the fishbowl swarm formation center at time step τ is given by:

ρ_{i,c}=∥ρ̅_{i,c}∥=∥x̅ᵢ−x̅_{c}∥ (3)

where ρ̅_{i,c} is the 3×1 position vector of spacecraft i with respect to swarm center, is the 3×1 position vector of the swarm formation center in the inertial reference frame, and x̅ᵢ is the 3×1 position vector of spacecraft i in the inertial reference frame.

As indicated by the double summation notation in Eq. (1), the terms Ri,τ are calculated and summed for each satellite in the swarm, i=1→n, and for each time step i=1→N, since the last action was taken at t-1.

To train the agent not to apply actions that cause the spacecraft to decay too low in altitude (for a low Earth orbit application, for example), a high penalty is applied in any epoch where the minimum altitude is violated (altitude penalty). That is,

$${P}_{i , τ} = \{ \begin{matrix}- {p}_{alt} & if {alt}_{i , τ} < {alt}_{min} \\ 0 & otherwise\end{matrix} \qquad ( 4 )$$

where Pi,τ is evaluated for each spacecraft at each time step, alt_{i,τ} is the altitude of each spacecraft at time τ, altₘᵢₙ is the minimum altitude that the spacecraft in the swarm must maintain, and pₐₗₜ is the scalar value penalty applied if any spacecraft decays below altₘᵢₙ.

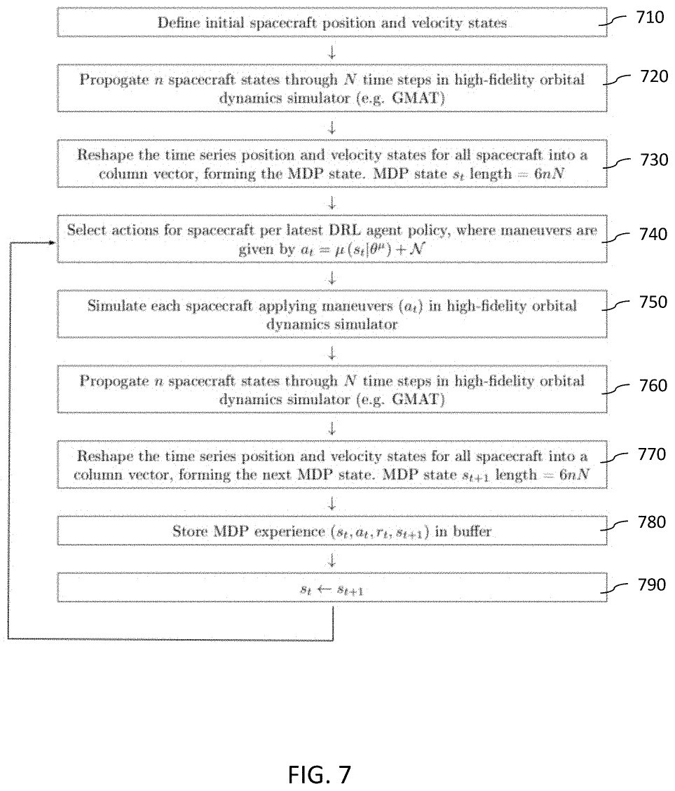

In Step 350, a process for training the DRL agent is implemented and iterated so as to produce evaluation metrics. In certain embodiments, the evaluation metrics can be the cumulative reward, the complexity of computing the actions, the percentage of epochs where swarm formation requirements are satisfied, the mission success rate which can be defined as the ratio of the number of simulated missions completed successfully to the number of simulated missions, etc. FIG. 7 illustrates a flow chart for the training process of Step 350 in further detail, thereby showing the interface between the orbital mechanics simulator inputs/outputs and the MDP state.

Referring to FIG. 7, in Step 710, initial position and velocity states of all of n spacecraft in a swarm is defined.

In Step 720, the initial position and velocity states are propagated in a high-fidelity simulation environment (e.g., GMAT) for N time steps.

In Step 730, the time series position and velocity states for N time steps are reshaped into a column vector thereby defining a first MDP state (Sₜ). Two example MDP vectors are shown in FIG. 4.

In Step 740, first actions (aₜ) are selected from the DRL agent for the spacecraft to maneuver In one embodiment, the first actions include a velocity change of each of the spacecraft and an exploration noise (i.e., μ(Sₜ|θ^{u})+N).

In Step 750, first actions (at) are applied to the spacecraft in the high-fidelity simulation environment so as to simulate maneuvering of the spacecraft.

In Step 760, the position and velocity states of the spacecraft are propagated in the high-fidelity simulation environment (e.g., GMAT) for N time steps based on the first actions (aₜ) applied to the spacecraft.

In Step 770, the time series position and velocity states propagaged for N time steps based on the first actions (at) are reshaped into a column vector thereby defining a second MDP state (Sₜ₊₁).

In Step 780, a reward signal (rₜ) is calculated based on the first actions (at) and the second MDP state (Sₜ₊₁) in a manner described above. In one embodiment, the first MDP state (Sₜ), the first actions (aₜ), the reward signal (rₜ), the second MDP state (Sₜ₊₁) can be stored in a buffer.

In Step 790, the first MDP state(St) is replaced by the second MDP state (Sₜ₊₁), if the reward signal is positive, and storing the updated MDP state as a part of the DRL agent.

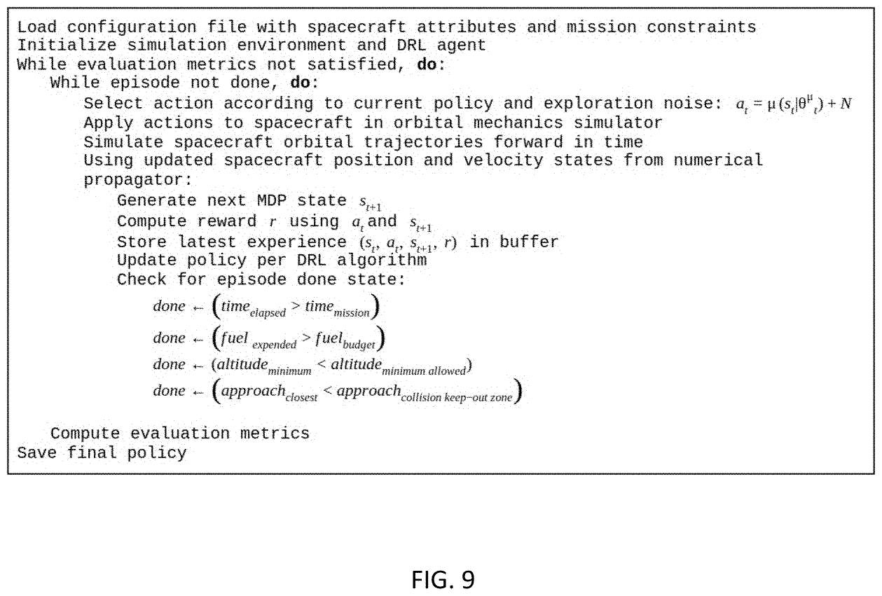

It is appreciated that Steps 740 through 790 an repeated until preset condition is met. In one embodiment, the preset condition can be one or more of: (i) an elapsed time being greater than a mission time, (ii) an expended fuel amount being greater than a budgeted fuel amount, (iii) a minimum spacecraft altitude being less than a minimum allowed altitude, and (iv) a closest distance among two of the spacecraft being less than a collision keep-out zone distance. The training process described above can be summarized as the pseudocode given in FIG. 9.

In Step 360, the DRL agent policy is output to a testing module 365 for evaluation under numerous testing scenarios.

In Step 370, the test results are evaluated. The evaluation can be done in multiple ways, such as testing in a simulation environment while randomizing the testing conditions, such as using different environmental conditions. This is important to evaluate how well the agent's model has generalized during training and confirm that it has not overfit a narrow task. This is also important for building confidence in the system and demonstrating that it is robust to variations in the environment.

One method of doing this can be to run a Monte Carlo simulation where the initial conditions of the simulation are varied and the agent's success rate is evaluated over a large number of simulations. Then, the agent's model may be used in conjunction with other spacecraft mission design and simulation tools. Evaluation metrics are computed for each simulated episode such as: cumulative reward, computational complexity of computing the action, percentage of epochs where swarm formation requirements were satisfied, the mission success rate which is defined as the ratio of the number of simulated missions completed successfully to the number of simulated missions, etc. Furthermore, along with varying the simulation initial conditions numerous scenarios can be simulated where the policy is tested when perturbations are introduced to the environment parameters, not only the states. These parameters can be but are not limited to, the spacecraft dry mass, propellant mass, off-nominal propulsion system performance, interspacecraft communication, alternative atmospheric drag models, etc all within the mission operational design domain.

Another method for evaluating the agent would be through hardware in the loop (HIL) type simulation; this is where the agent 210 is deployed on computational hardware similar to that that would be deployed in orbit, and synthetic simulation data is fed into the hardware using high fidelity simulation in a real-time manner. The agent 210 is tested for computational efficiency as well as mission success.

In Step 380, after sufficiently evaluating the agent's performance and using its model in spacecraft mission design tools, the DRL agent can then be deployed on spacecraft hardware for in-orbit use.

Once the spacecraft are deployed on-orbit, real-world data can be added to the Replay Buffer experience storage, supplementing the synthetic (simulated) data that was used to train the agent in the initial Training phase. In this case, the state vector St is populated with data from several possible sources, including but not limited to: spacecraft orbit estimates from ground-based orbit determination systems, GPS position and velocity estimates from GPS antenna+receiver onboard the spacecraft, relative spacecraft positioning from radio or optical sensors, geographic location of target to be observed or measured, etc.

Using the real-world, in-orbit experience data (states and actions), the agent can be re-trained, re-tested, and the updated policy deployed to the spacecraft. This is referred to as in-orbit learning. The present disclosure uses model-free reinforcement learning to train an agent to achieve a swarm spacecraft type. This means that there is no need to directly use first-principles type models to design/control the spacecraft trajectories. This also has the potential to generate novel solutions for designing/controlling the orbital trajectories of multi-spacecraft swarm system; models built using first-principles typically require assumption to be made to make the problem more tractable or for mathematical convenience, one example being linearization about an operating point. Such assumptions, while making the trajectory design problem feasible, may obscure solutions that, for example, could be more fuel or energy efficient. Since the DRL agent used in the present disclosure learns from interacting with a high-fidelity simulation environment 220 that makes no such assumptions, it could learn emergent behaviors that otherwise would be eliminated by assumptions from first-principle models.

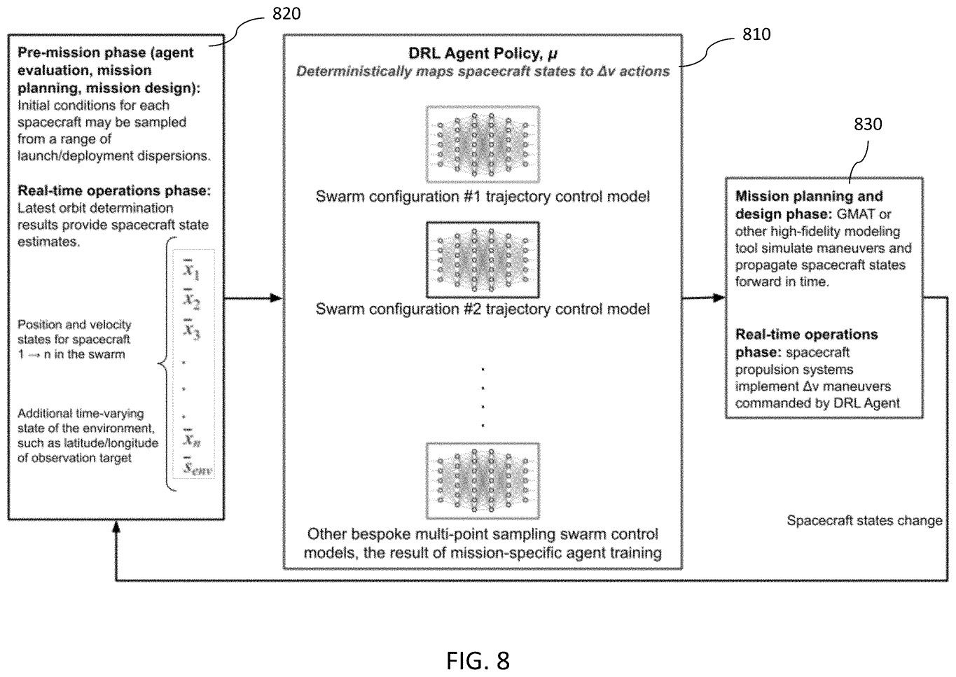

FIG. 8 illustrates a diagram of state inputs to various swarm configuration trajectory control models, in accordance with an embodiment of the present disclosure. The DRL agent policy 810 is deterministic. For spacecraft flight software validation and verification purposes, it is an advantage to have a deterministic policy that prescribes a single action for a given state, as opposed to a stochastic approach that could result in different action outputs for a given state input.

The agent 810 can be trained in simulation across a broad range of initial conditions and spacecraft states, allowing the deployed model to prescribe solutions under various starting times. The advantage is that the solution can provide maneuvers even under changing mission launch windows, changing start times of mission phases, etc. The training uses an off-policy method: the agent is able to learn across a large set of uncorrelated state observations. Prior simulation experience data are saved to a buffer and reused to continuously learn and improve the policy; this is referred to as experience replay.

Deploying the agent model on a spacecraft platform enables increased spacecraft autonomy. If the agent has inputs 820 from GPS and/or other sensors, the model can output what maneuvers 830 should be taken by the spacecraft in the system to achieve the desired swarm configuration.

In the pre-mission phase, inputs 820 can be initial conditions for each spacecraft sampled from a range of launch/deployment dispersions. In the real-time operation phase, inputs 820 can be the latest orbit determination results that provide spacecraft state estimates. Spacecraft states may include the position and velocity states for spacecraft 1 through n in a swarm. Spacecraft states may additional include time-varying state of the environment, such as the latitude/longitude of observation target.

In the mission planning and design phase, GMAT or other high-fidelity modeling tool can be used to simulate maneuvers 830 and propagate spacecraft states forward in time. In the real-time operation phase, spacecraft propulsion systems can implement the Av maneuvers 830 commanded by the DRL agent policy 810.

Ground operators can issue a single command to the swarm as a collective, rather than issuing commands to each spacecraft individually. This reduces the overhead of uplink communication from the Earth to the spacecraft swarm.

Prior art methods generally require an iterative numerical optimization process for solving for orbit trajectories for each individual spacecraft in the swarm. This can be computationally intensive during deployment (i.e., during real-time mission operations). The present disclosure provides a method to learn such solutions a priori and use an agent model to infer them during operation, requiring substantially less computational steps, since neural network inference involves a standard linear algebra computation.

The agent can learn how to achieve desired formation without being explicitly shown what spacecraft relative-positioning to achieve. Through the designed reward signals, the policy can find fuel optimal solutions to achieve desired formation.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical value appearing in the present disclosure are deemed modified by a term of degree (e.g., “about”), thereby reflecting its intrinsic uncertainty.

Although various embodiments of the present disclosure have been described in detailed herein, one of ordinary skill in the art would readily appreciate modifications and other embodiments without departing from the spirit and scope of the present disclosure as stated in the appended claims.

What is claimed is:

1. A method for controlling orbital trajectories of a plurality of spacecraft in a multi-spacecraft swarm, comprising:
deploying a DRL agent including a plurality of trajectory control models to the multi-spacecraft swarm, the trajectory control models corresponding to swarm configurations of the multi-spacecraft swarm;
determining a state vector of said plurality of spacecraft in the multi-spacecraft swarm;
transmitting a collective command to the multi-spacecraft swarm, such that said plurality of spacecraft in the multi-spacecraft swarm are to be distributed in one of the swarm configurations;
determining actions of said plurality of spacecraft based on the state vector and the collective command in accordance with one of the trajectory control models of the DRL agent; and
maneuvering the multi-spacecraft swarm in accordance with the actions.

2. The method of claim 1, prior to deploying the DRL agent, further comprising training the DRL agent using a high-fidelity orbital mechanics simulation.

3. The method of claim 2, wherein training the DRL agent policy comprises:
providing a positive reward signal to the DRL agent when said plurality of spacecraft maintains a desired separation distance between each other in a desired swarm configuration.

4. The method of claim 2, wherein training the DRL agent policy comprises:
providing a negative reward signal to the DRL agent when longer than a preset time period is taken for said plurality of spacecraft to form the desired swarm configuration.

5. The method of claim 2, wherein training the DRL agent policy comprises:
providing a negative reward signal to the DRL agent when more fuel than a preset amount is consumed for said plurality of spacecraft to maneuver the multi-spacecraft swarm in accordance with the actions.

6. A method for training a DRL agent of a spacecraft swarm including a plurality of spacecraft, the method comprising:
(A) defining a first MDP state including first position and velocity states of the spacecraft propagated in a high-fidelity simulation environment for a plurality of time steps;
(B) selecting from the DRL agent first actions for the spacecraft to maneuver, the first actions including a velocity change of each of the spacecraft and an exploration noise;
(C) maneuvering the spacecraft in a high-fidelity simulation environment in accordance with the first actions for said plurality of time steps, thereby generating a second MDP state including second position and velocity states of the spacecraft for said plurality of time steps;
(D) calculating a reward signal based on the first actions and the second MDP state;
(E) replacing the first MDP state by the second MDP state, if the reward signal is positive; and
(F) storing the first MDP state as a part of the DRL agent.

7. The method of claim 6, further comprising repeating steps (B) through (E) until a preset condition is met.

8. The method of claim 7, wherein the preset condition includes at least one of an elapsed time being greater than a mission time, an expended fuel amount being greater than a budgeted fuel amount, a minimum spacecraft altitude being less than a minimum allowed altitude, and a closest distance among two of the spacecraft being less than a collision keep-out zone distance.

9. The method of claim 6, further comprising evaluating the DRL agent in a simulation environment with randomized testing conditions.

10. The method of claim 4, wherein evaluating the DRL agent comprises:
providing different initial conditions of the spacecraft in the simulation environment;
maneuvering the spacecraft in the simulation environment using various actions in the DRL agent; and
determining evaluation metrics for the spacecraft to maneuver in accordance with said various actions.

11. The method of claim 10, further comprising introducing perturbations to the simulation environment.

12. The method of 10, wherein the evaluation metrics comprise at least one of a cumulative reward, a complexity of computing the actions, a percentage that swarm formation requirements are satisfied, and a mission success rate defined as a ratio of a number of successfully completed simulated missions to a number of all simulated missions.

13. The method of claim 6, wherein calculating the reward signal comprises providing a positive value to the DRL agent when said plurality of spacecraft maintains a desired separation distance between each other in a desired swarm configuration.

14. The method of claim 6, wherein calculating the reward signal comprises providing a negative value to the DRL agent when longer than a preset time period is taken for said plurality of spacecraft to form a desired swarm configuration.

15. The method of claim 6, wherein calculating the reward signal comprises providing a negative value to the DRL agent when more fuel than a preset amount is consumed for said plurality of spacecraft to maneuver the spacecraft swarm in accordance with the actions.
